(19) United States
(12) Patent Application Publication
(10) Pub. No.: US 2025/0227650 A1
(43) Pub. Date: Jul. 10, 2025

(54) METHOD AND APPARATUS OF SIDELINK POSITIONING

(71) Applicant: LENOVO (BEIJING) LIMITED, Beijing (CN)

(72) Inventors: Xiaodong YU, Beijing (CN); Zhennian SUN, Beijing (CN); Haipeng LEI, Beijing (CN); Jie HU, Beijing (CN); Xin GUO, Beijing (CN)

(21) Appl. No.: 18/703,162

(22) PCT Filed: Oct. 22, 2021
(86) PCT No.: PCT/CN2021/125731

§ 371 Date: Apr. 19, 2024

(51) Int. Cl. H04W 64/00; G01S 5/02; H04L 5/00; H04W 72/25

(52) U.S. Cl. CPC H04W 64/00; G01S 5/0244; H04L 5/0048; H04W 72/25

(57) ABSTRACT

Embodiments of the present application relate to a method and apparatus of sidelink (SL) positioning. An exemplary UE includes: at least one receiving circuitry; at least one transmitting circuitry; and at least one processor coupled to the at least one receiving circuitry and the at least one transmitting circuitry, wherein the at least one processor is configured to: transmit accuracy level information indicating a positioning accuracy level associated with the UE to a set of reception UE; and transmit an SL PRS corresponding to the accuracy level information to a reception UE, wherein the reception UE is one of the set of reception UE or not.

### TECHNICAL FIELD

Embodiments of the present application are related to wireless communication technology, especially, related to sidelink (SL) positioning.

### BACKGROUND OF THE INVENTION

In a wireless communication system, a user equipment (UE), e.g., mobile device, may communicate with another UE via a data path supported by an operator's network, e.g. a cellular or a Wi-Fi network infrastructure. The data path supported by the operator network may include a base station (BS) and multiple gateways.

In the case that both UEs are relatively close to each other, a radio link or an SL can be established between both UEs to provide direction communication and without going through a link to the BS. The term “SL” may refer to a direct radio link established for communicating among devices, e.g., UEs, as opposed to communication link via the cellular infrastructure (uplink and downlink) as discussed above. The term “SL” may also refer to a sidelink communication link.

In addition, different from network based positioning where UE's position is calculated by a network node, SL positioning provides a new positioning method where UE's position is calculated based on an SL positioning reference signal (PRS) from an SL PRS transmission UE. SL positioning has various advantages including but not limited to: operate independently from network or radio access technology (RAT) coverage and is very valuable when network based positioning or other positioning methods are not available. Thus, there is strong demand from the industry to require the support of SL positioning, such as vehicle platooning, extended sensors, advanced driving and remote driving.

However, there are still several technical problems to be solved for SL positioning to improve SL positioning accuracy.

### SUMMARY

One objective of the embodiments of the present application is to provide a technical solution for wireless communication, especially for SL positioning.

Some embodiments of the present application provide a UE, which includes: at least one receiving circuitry; at least one transmitting circuitry; and at least one processor coupled to the at least one receiving circuitry and the at least one transmitting circuitry, wherein the at least one processor is configured to: transmit, via the at least one transmitting circuitry, accuracy level information indicating a positioning accuracy level associated with the UE to a set of reception UE; and transmit, via the at least one transmitting circuitry, an SL PRS corresponding to the accuracy level information to a reception UE, wherein the reception UE is one of the set of reception UE or not.

In some embodiments of the present application, the accuracy level information is transmitted in SL control information.

In some embodiments of the present application, the accuracy level information is specific source identity value information or specific destination identity value information transmitted in the SL control information.

In some embodiments of the present application, transmitting the SL PRS is in response to request information from the reception UE.

In some embodiments of the present application, the positioning accuracy level is one of a plurality of positioning accuracy levels predefined according to a standard or configured by a network apparatus. The plurality of positioning accuracy levels are predefined or configured based on at least one of the following: a calculation manner of an absolute position of an SL PRS transmission UE; a calculation entity of an absolute position of an SL PRS transmission UE; or a combination of the calculation manner with the calculation entity of an absolute position of an SL PRS transmission UE. Priorities of the plurality of positioning accuracy levels are predefined according to the standard or configured by the network apparatus.

In some embodiments of the present application, the at least one processor is configured to: receive, via the at least one receiving circuitry, resource pool configuration information of a set of resource pool from a network apparatus, wherein each resource pool of the set of resource pool is configured to be corresponding to one or more positioning accuracy levels. The at least one processor is configured to: transmit, via the at least one transmitting circuitry, the SL PRS in a resource pool at least corresponding to the positioning accuracy level of the set of resource pool.

In some embodiments of the present application, the SL PRS is transmitted after a channel access detection, and at least one of contention window size and back-off time of the channel access detection is associated with the positioning accuracy level.

Some embodiments of the present application provide another UE, which includes: at least one receiving circuitry; at least one transmitting circuitry; and at least one processor coupled to the at least one receiving circuitry and the at least one transmitting circuitry, wherein the at least one processor is configured to: determine a positioning accuracy level desired by the UE; and receive, via the at least one receiving circuitry, an SL PRS corresponding to accuracy level information indicating the positioning accuracy level from a transmission UE.

In some embodiments of the present application, the accuracy level information is received in SL control information.

In some embodiments of the present application, the at least one processor is configured to: receive, via the at least one receiving circuitry, resource pool configuration information of a set of resource pool from a network apparatus, wherein each resource pool of the set of resource pool is configured to be corresponding to one or more positioning accuracy levels. The at least one processor is configured to: receive, via the at least one receiving circuitry, the SL PRS in a resource pool at least corresponding to the positioning accuracy level of the set of resource pool.

In some embodiments of the present application, the SL PRS is received after a channel access detection, and at least one of a contention window size and back-off time of the channel access detection is associated with the positioning accuracy level.

In some embodiments of the present application, the at least one processor is further configured to: receive, via the at least one receiving circuitry, the accuracy level information from the transmission UE before receiving the SL PRS. In some other embodiments of the present application, the at least one processor is further configured to: transmit, via the at least one transmitting circuitry, request information indicating the positioning accuracy level desired by the UE to the transmission UE, before receiving the SL PRS.

Some embodiments of the present application provide a network apparatus, which includes: at least one receiving circuitry; at least one transmitting circuitry; and at least one processor coupled to the at least one receiving circuitry and the at least one transmitting circuitry, wherein the at least one processor is configured to: configure at least one of: level configuration information on a plurality of positioning accuracy levels for PRS transmission; and priority configuration information on priorities of the plurality of positioning accuracy levels for the PRS transmission; and transmit, via the at least one transmitting circuitry, to a UE, configuration information indicating at least one of: the level configuration information and the priority configuration information.

In some embodiments of the present application, the at least one processor is configured to: further transmit, via the at least one transmitting circuitry, resource pool configuration information of a set of resource pool, wherein each resource pool of the set of resource pool is configured to be corresponding to one or more of the plurality of positioning accuracy levels.

In some embodiments of the present application, both the plurality of positioning accuracy levels and the priorities of the plurality of positioning accuracy levels are configured by the network apparatus. In some other embodiments of the present application, either the plurality of positioning accuracy levels or the priorities of the plurality of positioning accuracy levels are configured by the network apparatus.

Given the above, embodiments of the present application propose a novel SL positioning solution, which will improve the accuracy of SL positioning, especially the accuracy of SL absolute positioning.

### BRIEF DESCRIPTION OF THE DRAWINGS

In order to describe the manner in which advantages and features of the present application can be obtained, a description of the present application is rendered by reference to specific embodiments thereof which are illustrated in the appended drawings. These drawings depict only exemplary embodiments of the present application and are not therefore intended to limit the scope of the present application.

FIG. 1A is a schematic view of an exemplary in-coverage scenario according to some embodiments of the present application.

FIG. 1B is a schematic view of an exemplary partial coverage scenario according to some other embodiments of the present application.

FIG. 1C is a schematic view of an exemplary out-of-coverage scenario according to some yet other embodiments of the present application.

FIG. 2 is a flow chart illustrating an exemplary procedure of a method of SL positioning according to some embodiments of the present application.

FIG. 3 is a flow chart illustrating an exemplary procedure of a method of SL positioning according to some other embodiments of the present application.

FIG. 4 is a flow chart illustrating an exemplary procedure of a method of SL positioning according to some yet other embodiments of the present application.

FIG. 5 illustrates a block diagram of an apparatus of SL positioning according to some embodiments of the present application.

FIG. 6 illustrates a block diagram of an apparatus of SL positioning according to some other embodiments of the present application.

### DETAILED DESCRIPTION

The detailed description of the appended drawings is intended as a description of the currently preferred embodiments of the present application and is not intended to in represent the only form in which the present application may be practiced. It is to be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3rd generation program group (3GPP) 5G, 3GPP long term evolution (LTE), and so on. It is contemplated that along with the developments of network architectures and new service scenarios, all embodiments in the present application are also applicable to similar technical problems. Moreover, the terminologies recited in the present application may change, which should not affect the principle of the present application.

SL communication supports UE-to-UE direct communication. In the context of the present application, SL communication may be categorized according to the wireless communication technologies adopted. For example, SL communication may include new radio (NR) SL communication and V2X SL communication etc.

NR SL communication (e.g., specified in 3GPP specification TS 38.311) may refer to access stratum (AS) functionality enabling at least vehicle-to-everything (V2X) communication as defined in 3GPP specification TS 23.287 between neighboring UEs, using NR technology but not traversing any network node. V2X SL communication (e.g., specified in 3GPP specification TS 36.311) may refer to AS functionality enabling V2X communication as defined in 3GPP specification TS 23.285 between neighboring UEs, using evolved-universal mobile telecommunication system (UMTS) terrestrial radio access (UTRA) (E-UTRA) technology, but not traversing any network node. However, if not being specified, “SL communication” may refer to NR SL communication, V2X SL communication, or any SL communication adopting other wireless communication technologies.

For SL communication, three network coverage scenarios, i.e., in-coverage scenario, partial coverage scenario and out-of-coverage scenario can be considered when at least two UEs are involved in positioning for V2X and public safety application. Taking two UEs as an example, the in-coverage scenario refers to the case where both the two UEs are inside the network; the partial coverage scenario refers to that only one UE remains inside the network coverage but the other UE is outside the network coverage; and the out-of-coverage scenario refers to the case where both the two UEs are outside the network coverage. A UE may transfer among the in-coverage scenario, partial coverage scenario and out-of-coverage scenario.

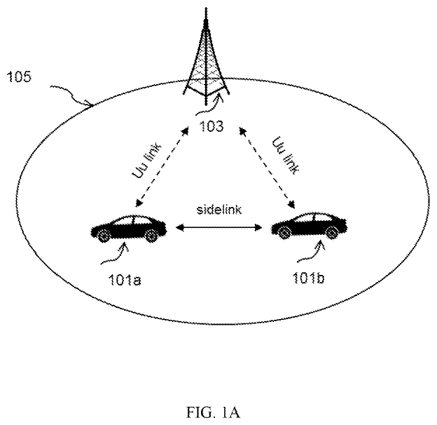

FIGS. 1A-1C illustrate examples of the three network coverage scenarios respectively, wherein, FIG. 1A is a schematic view of an exemplary in-coverage scenario according to some embodiments of the present application, FIG. 1B is a schematic view of an exemplary partial coverage scenario according to some other embodiment of the present application, and FIG. 1C is a schematic view of an exemplary out-of-coverage scenario according to some yet other embodiment of the present application.

In each exemplary network coverage scenario, there are a plurality of UEs, such as a first UE 101a and second UE 101b, and a base station 103, which are shown for illustrating the embodiment of the present application in a simplified manner. Persons skilled in the art should understand there can be more base stations 103 and more UEs in or outside of the coverage of the base stations 103. The wording “first” and “second” are only used to clearly illustrate the embodiments of the present application, and should not be used to limit the substance of the present application.

The UEs and base station 103 may support communication based on, for example, 3G, LTE, LTE-advanced (LTE-A), NR, or other suitable protocol(s). In some embodiments of the present application, the BS 103 may be referred to as an access point, an access terminal, a base, a base unit, a macro cell, a Node-B, an evolved Node B (eNB), a gNB, an ng-eNB, a home Node-B, a relay node, or a device, or described using other terminology used in the art. Although the first UE 101a or second UE 101b are shown as vehicles, the UEs, e.g., the first UE 101a or second UE 101b may be any terminal device, for example, but is not limited to, a computing device, a wearable device, a mobile device, an internet of things (IoT) device, a road side unit (RSU), etc.

The base station 103 may define one or more cells, and each cell may have a coverage area 105. As shown in FIG. 1A, in the in-coverage scenario, both the first UE 101a and second UE 101b are within the coverage of the base station 103. The first UE 101a and the second UE 101b may exchange V2X messages with the base station 103 via, for example, a Uu link, and exchange V2X messages between each other through a SL, for example, a PC5 interface as defined in TS 23.303. During the communication between two UEs, one UE may act as a transmitter, i.e., a transmission UE (hereinafter referred to as “Tx UE”), and the other UE may act as a receiver, i.e., a reception UE (hereinafter referred to as “Rx UE”). The Tx UE, for example the first UE 101a, may initiate a unicast transmission to the Rx UE, for example 101b, and the Rx UE 101b may receive the unicast transmission from the Tx UE, for example the first UE 101a.

As shown in FIG. 1B, in the partial coverage scenario, only one UE, e.g., the first UE 101a is within the coverage of the base station 103, and the second UE 101b is outside of the coverage of the base station 103, versa vice. Similarly, the first UE 101a may exchange V2X messages with the base station 103 via Uu link, and exchange V2X messages with the second UE 101b through a SL, for example, PC5 interface as defined in TS 23.303. Since the second UE 101b is outside of the coverage range associated with the base station 103, it cannot exchange messages with the base station 103 via Uu link. During the communication between the two UEs, the first UE 101a may act as a Tx UE and initiate a unicast transmission, the second UE 101b may act as a Rx UE and receive the unicast transmission from the Tx UE, and vice versa.

As shown in FIG. 1C, in the out-of-coverage scenario, both the first UE 101a and the second UE 101b are outside of the coverage of the base station 103, and cannot exchange messages with the base station 103 via Uu link. However, the first UE 101a may exchange V2X messages with the second UE 101b through SL, for example, PC5 interface as defined in TS 23.303. During the communication between the two UEs, the first UE 101a may act as a Tx UE and initiate a unicast transmission, and the second UE 101b may act as a Rx UE and receive the unicast transmission from the Tx UE, and vice versa.

Generally, according to the agreements of 3GPP standard documents, in a 3GPP 5G NR SL system or the like, RAT-dependent positioning is supported by LTE and NR, and observed time difference of arrival (OTDOA) is used for positioning a UE in LTE and NR. OTDOA is a multilateration method, in which a UE measures the time of arrival (TOA) of signals received from multiple BSs. RAT-dependent positioning is only available in a cellular network coverage area and tends to have a high latency due to the exchanges between radio and core network elements. Considering the above issues of RAT-dependent positioning, an SL positioning mechanism is proposed in R17.

In particular, the SL positioning mechanism may work independently from or collaboratively with the current RAT-dependent positioning techniques. The SL positioning mechanism can add a unique benefit of positioning availability, especially in the partial coverage scenario and out-of-coverage scenario for applications (such as, public safety) that should operate independently from the network coverage. In addition, the SL positioning mechanism has potential advantages to improve the accuracy of Uu-link positioning by sharing positioning related information through a SL, even within the network coverage areas. The SL positioning mechanism can also provide positioning related information regarding lower-latency service(s) due to removal of signaling between different network elements.

In addition, SL positioning is categorized as SL relative positioning and SL absolute positioning (hereafter, also referred to as “absolute positioning”), wherein the absolute positioning represents geographical location of a UE, e.g., latitude and longitude etc. There are two SL positioning scenarios, i.e., 1) always transmitting, e.g., SL PRS being transmitted from RSU; and 2) trigger-based transmitting, e.g., SL PRS being transmitted from a UE. A UE which transmits SL PRS(s) is referred to as an SL PRS transmission UE or an SL PRS transmission source or PRS transmission UE or transmission UE, while a UE which expects or receives SL PRS(s) is referred to as an SL PRS reception UE or PRS reception UE or reception UE. Apparently, if the absolute position of SL PRS transmission UE is inaccurate, based on this SL PRS transmission, the measured absolute position of the corresponding SL PRS reception UE will also be inaccurate. Thus, how to select (or determine) the SL PRS transmission UE is a very important issue for SL positioning, especially, for SL absolute positioning. A simple solution is that an SL PRS reception UE selects an SL PRS transmission UE (or source) based on the network coverage scenario of the SL PRS transmission UE. However, this solution is not reasonable. For example, a UE in the coverage of the network may have a lower positioning accuracy than another UE which is located out of the coverage of the network and uses a global navigation satellite system (GNSS) for positioning measurement. Thus, how to select the SL PRS transmission UE or SL PRS transmission source should be seriously considered to increase the accuracy of SL absolute positioning.

At least to solve the above technical problems, embodiments of the present application propose a technical solution of SL positioning, e.g., a method of SL positioning and an apparatus of SL positioning.

According to some embodiments of the present application, at least one positioning accuracy level (or referred to as “SL PRS source accuracy level” or “SL PRS accuracy level” or “SL absolute positioning accuracy level” etc.) is provided for absolute positioning. The at least one positioning accuracy level can be predefined in standard(s) or is configured by the network. A positioning accuracy level indicates the accuracy level of the absolute position of a UE (or the accuracy level of the SL PRS from the UE), which may be used as an SL PRS transmission UE.

For example, a first exemplary positioning accuracy level is the accuracy level of the absolute position of a UE measured by a hybrid GNSS based and Uu interface-based method (or measurement). The absolute position of a UE can be configured or indicated by the network, e.g., a gNB in some embodiments of the present application. For example, the network calculates the absolute position of the UE based on UE reported information, and then configures or indicates it to UEs. In some other embodiments of the present application, the absolute position of a UE can be measured by the UE itself, e.g., based on GNSS information.

A second exemplary positioning accuracy level is the accuracy level of the absolute position of a UE measured by a GNSS based method (or measurement). Similarly, the absolute position of a UE can be configured or indicated by the network, e.g., a gNB in some embodiments of the present application. For example, the network calculates the absolute position of the UE based on UE reported information, and then configures or indicates it to UEs. In some other embodiments of the present application, the absolute position of a UE can be measured by the UE itself, e.g., based on GNSS information.

A third exemplary positioning accuracy level is the accuracy level of the absolute position of a UE measured by a Uu interface-based method (or measurement). For example, the absolute position of a UE is computed based on a downlink (DL) PRS. Similarly, the absolute position of a UE can be configured or indicated by the network, e.g., a gNB in some embodiments of the present application. For example, the network calculates the absolute position of the UE based on UE reported information, and then configures or indicates it to UEs. In some other embodiments of the present application, the absolute position of a UE can be measured by the UE itself, e.g., based on GNSS information.

A fourth exemplary positioning accuracy level is the accuracy level of the absolute position of a UE measured based on SL PRSs from one or more other UE(s) and the absolute position of the one or more other UE(s). In this case, the absolute position of a UE can be measured by another UE, e.g., an SL PRS transmission UE or an SL PRS reception UE.

All or part of the above four exemplary positioning accuracy levels can be predefined or configured. In addition, more other positioning accuracy level can be further defined and can be used with all or part of the four exemplary positioning accuracy levels. In the case that there are a plurality of positioning accuracy levels, priorities of the plurality of positioning accuracy levels will be provided for SL positioning. In some cases, a positioning accuracy level which is supposed to be more accurate than another will be a positioning accuracy level with higher priority. The UE with positioning accuracy level in higher priority will be selected as the SL PRS transmission UE in higher priority than that with positioning accuracy level in lower priority. Similarly, the priorities of the plurality of positioning accuracy levels can be predefined according to the standard or configured by the network apparatus.

According to some embodiments of the present application, the plurality of positioning accuracy levels can be predefined or configured based on at least one of the following: a calculation manner of an absolute position of an SL PRS transmission UE; a calculation entity of an absolute position of an SL PRS transmission UE; or a combination of the calculation manner with the calculation entity of an absolute position of an SL PRS transmission UE.

For example, based on the calculation manner of an absolute position of an SL PRS transmission UE, the priorities of the above four exemplary positioning accuracy levels may be defined as: the priority of the first positioning accuracy level is higher than that of the second positioning accuracy level, the priority of the second positioning accuracy level is higher than that of the third positioning accuracy level, and the priority of the third positioning accuracy level is higher than that of the fourth positioning accuracy level; versa vice.

For another example, the plurality of positioning accuracy levels can be predefined or configured based on the calculation entity of an absolute position of an SL PRS transmission UE. In an in-coverage scenario, the absolute position of an SL PRS transmission UE can be calculated (or measured) or indicated by the network based on: sounding reference signaling on uplink (UL), or reported DL PRS measurement information, or reported GNSS information. In an out-of-coverage scenario, the absolute position of an SL PRS transmission UE can be calculated (or measured) by the UE itself based on: DL PRS, GNSS, or SL PRS transmitted from other UE(s). Then, based on the calculation entity (or measurement entity) of the absolute position of an SL PRS transmission UE, a priority rule can be defined as that the positioning accuracy level of the absolute position of the SL PRS transmission UE calculated by the network has higher priority than that calculated by UEs, vice visa.

In some embodiments of the present application, more than one priority rule can be combined together. A further priority rule can be defined within a positioning accuracy level. For example, for the fourth exemplary positioning accuracy level, a further priority rule can be defined as that the SL PRS from a UE, who absolute position is calculated or measured based on GNSS information has a higher priority than that not based on GNSS information. In an exemplary embodiment of the present application, the absolute position of a first UE can be computed based on either the SL PRS from a second UE or the SL PRS from a third UE. The absolute position of the second UE is computed or measured based on the SL PRS from a fourth UE, while the absolute position of the third UE is computed or measured based on the SL PRS from a fifth UE, wherein the absolute position of the fourth UE is based on GNSS information while the fifth UE is not. Then, based on the further priority rule, the priority of the positioning accuracy level of the second UE is higher than that of the third UE. That is, the second UE can be selected as the SL PRS transmission UE by the first UE in higher priority than the third UE.

Based on the plurality of positioning accuracy levels and priorities of the plurality of the positioning accuracy level, how an SL PRS transmission UE is selected and how the SL positioning is performed will be further illustrated with exemplary embodiments.

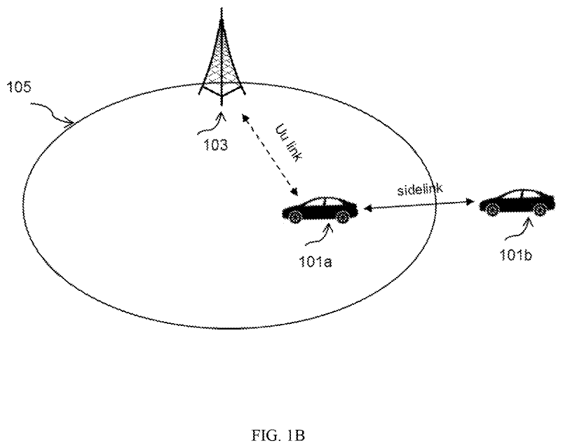

FIG. 2 is a flow chart illustrating an exemplary procedure of a method of SL positioning according to some embodiments of the present application. The method can be implemented by a network apparatus in the network side, e.g., a gNB or another apparatus with like functions.

As shown in FIG. 2, in step 201, the network apparatus e.g., a gNB may configure (including pre-configure) at least one of: level configuration information a plurality of positioning accuracy levels for PRS transmission; and priority configuration information on priorities of the plurality of positioning accuracy levels for the PRS transmission.

For example, the network apparatus may only configure the level configuration information on a plurality of positioning accuracy levels for PRS transmission, e.g., information on one or more positioning accuracy levels corresponds to one or more SL PRS transmission UEs. In another example, the network apparatus may only configure the priority configuration information on priorities of the plurality of positioning accuracy levels for the PRS transmission, e.g., the absolute position of SL PRS transmission UE calculated by the network is configured to have higher priority than that calculated by UE, or the absolute position of SL PRS transmission UE calculated based on GNSS by UE is configured to have higher priority than that calculated based on DL PRS or SL PRS by the UE. In yet another example, the network apparatus may configure both the level configuration information and the priority configuration information.

Then, in step 203, the network apparatus may transmit, to a UE or more UEs, configuration information indicating at least one of: the level configuration information and the priority configuration information. UEs receiving the configuration information from the network apparatus may be an SL PRS transmission UE or an SL PRS reception UE.

For example, in the case that the network apparatus only configures the level configuration information, the network apparatus may transmit a signaling indicating the level configuration information to the UE, e.g., by radio resource control (RRC) etc., high layer signaling. In the case that the network apparatus only configures the priority configuration information, the network apparatus may transmit a signaling indicating the priority configuration information to the UE, e.g., by RRC etc., high layer signaling. In the case that the network apparatus configures both the level configuration information and the priority configuration information, the network apparatus may transmit a signaling indicating both the level configuration information and the priority configuration information to the UE, e.g., by RRC etc. high layer signaling.

In some embodiments of the present application, the network side may configure the plurality of positioning accuracy levels in the resource pool configuration for UEs regardless of whether being SL PRS transmission UEs or SL PRS reception UEs. The network apparatus may transmit resource pool configuration information of a set of resource pool, wherein each resource pool of the set of resource pool is configured to be corresponding to one or more of the plurality of positioning accuracy levels. Herein, the wording “a set of” means one or more, or at least one. Accordingly, the SL PRS transmission UE will transmit the SL PRS in a resource pool at least corresponding to the positioning accuracy level of the set of resource pool, and the SL PRS reception UE will receive the SL PRS in a resource pool at least corresponding to the positioning accuracy level of the set of resource pool.

Table 1 illustrates exemplary resource pool configuration information below, wherein the wording “equal or higher than” means that the corresponding resource pool can be used to transmit the SL PRS with more than one positioning accuracy levels. For example, for resource pool index 2, equal or higher than the second positioning accuracy level means the first and the second positioning accuracy levels. For resource pool index 3, equal or higher than the third positioning accuracy level means the first, the second and the third positioning accuracy levels. For resource pool index 4, equal or higher than the fourth positioning accuracy level means the first, the second, the third and the fourth positioning accuracy level. For resource pool index 5, equal or higher than the fifth positioning accuracy level means the first, the second, the third, the fourth and the fifth positioning accuracy level.

TABLE 1

| Resource | |
|---|---|
| pool index | positioning accuracy level |
| 1 | the first positioning accuracy level |
| 2 | equal or higher than the second positioning accuracy |
| | level |
| 3 | equal or higher than the third positioning accuracy |
| | level |
| 4 | equal or higher than the fourth positioning accuracy |
| | level |
| 5 | equal or higher than the fifth positioning accuracy |
| | level |

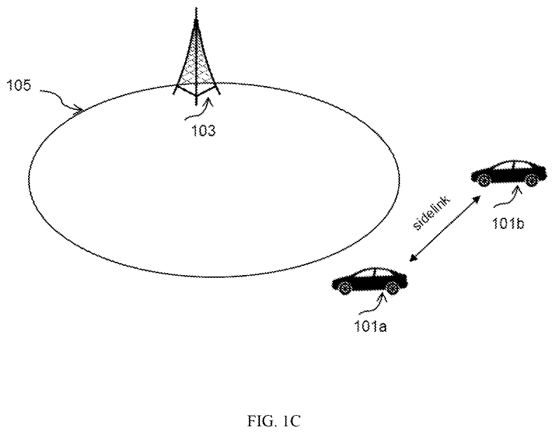

FIG. 3 is a flow chart illustrating an exemplary procedure of a method of SL positioning according to some embodiments of the present application. The method can be implemented by a UE in the remote side, e.g., an SL PRS transmission UE or another apparatus with like functions.

As show in step 301, the SL PRS transmission UE may transmit, accuracy level information indicating a positioning accuracy level associated with the UE to a set of reception UE, i.e., a set of SL PRS reception UE. Herein, the wording “a set of” means one or more, or at least one. Persons skilled in the art should well know that the UE may have a plurality of positioning accuracy level because its absolute position can be calculated or measured in various manners. However, for a certain SL PRS from the UE, only one positioning accuracy level is considered.

In some embodiments of the present application, the SL PRS transmission UE may always transmit the accuracy level information to a set of reception UE, e.g., in the always transmitting SL PRS scenario. An SL PRS reception UE may receive the accuracy level information, and use it for SL PRS transmission UE selection. In some other embodiments of the present application, the SL PRS transmission UE may transmit the accuracy level information to an SL PRS reception UE in response to the request information from the reception UE, e.g., in the trigger-based transmitting SL PRS scenario.

According to some embodiments of the present application, the accuracy level information is explicitly or implicitly transmitted in SL control information. The SL control information is used for indicating or scheduling its associated SL PRS transmission. The SL PRS reception UE receives the SL control information and determines positioning accuracy level of the SL PRS transmission from the SL PRS transmission UE. In some embodiments of the present application, the accuracy level information is specific source identity value information or specific destination identity value information transmitted in the SL control information.

In step 303, the SL PRS transmission UE may transmit an SL PRS corresponding to the accuracy level information to an SL PRS reception UE. The SL PRS reception UE may be a reception UE of the set of reception UE that receives the always transmitted accuracy level information, or is a reception UE that requests the accuracy level information with a trigger signaling etc.

When the SL PRS transmission UE receives resource pool configuration information of a set of resource pool from a network apparatus, wherein each resource pool of the set of resource pool is configured to be corresponding to one or more positioning accuracy levels. Then, when transmits the SL PRS, the SL PRS transmission UE will transmit the SL PRS in a resource pool at least corresponding to the positioning accuracy level of the set of resource pool.

In addition, for channel access on unlicensed band, at SL PRS transmission UE side, if listen before talk (LBT) is used for subsequent SL PRS transmission, the SL PRS is transmitted after a channel access detection, and at least one of contention window size and back-off time of the channel access detection is associated with the positioning accuracy level of the SL PRS. For example, the higher priority of the positioning accuracy level, the easier (e.g., short size of contention window or short maximum back-off time) to access channel for subsequent SL PRS transmission.

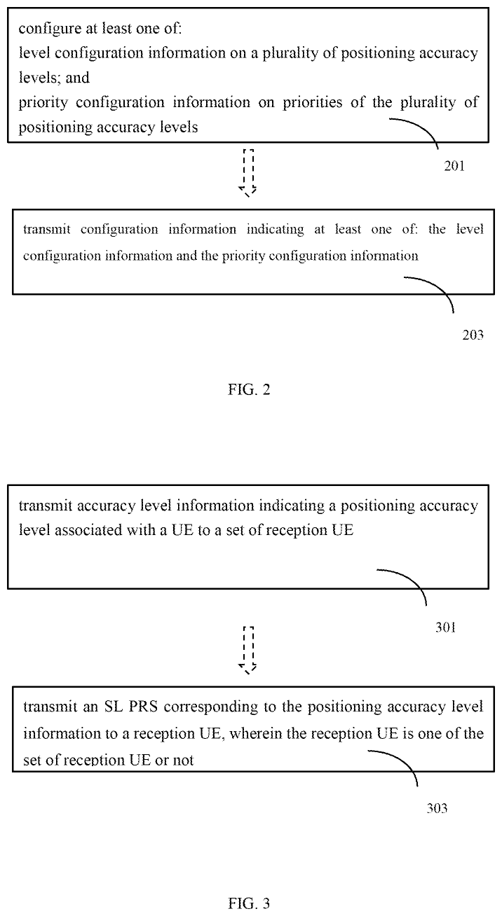

FIG. 4 is a flow chart illustrating an exemplary procedure of a method of SL positioning according to some embodiments of the present application. The method can be implemented by a UE in the remote side, e.g., an SL PRS reception UE or another apparatus with like functions.

As shown in step 401, the SL PRS reception UE may determine a positioning accuracy level desired, e.g., a first positioning accuracy level as illustrated above. In some embodiments of the present application, the SL PRS reception UE may select an SL PRS transmission UE with the desired positioning accuracy level based on received accuracy level information from a plurality of UEs, which is not requested by the SL PRS reception UE by request information. That is, the SL PRS reception UE will receive the accuracy level information indicating the desired positioning accuracy level from the SL PRS transmission UE before receiving the SL PRS.

In some embodiments of the present application, the SL PRS reception UE may request an SL PRS with the desired positioning accuracy level. For example, the SL PRS reception UE may transmit a triggering signaling, which explicitly or implicitly indicates the desired positioning accuracy level. That is, the SL PRS reception will transmit the request information indicating the desired positioning accuracy level to the SL PRS transmission UE before receiving the SL PRS. The triggering signaling explicitly or implicitly indicates the desired positioning accuracy level can be transmitted to a plurality of SL PRS UEs. The SL PRS transmission UE, which receives the request information can provide the SL PRS with the desired positioning accuracy level, may transmit a signaling indicating its positioning accuracy level and the associated SL PRS to the SL PRS reception UE. In some embodiments of the present application, the signaling indicating the positioning accuracy level from the SL PRS transmission UE may indicate the highest priority of the positioning accuracy level that it can provide.

Accordingly, after determining the SL PRS transmission UE, the SL PRS reception UE receives an SL PRS corresponding to the desired positioning accuracy level from an SL PRS transmission UE in step 403.

In some embodiments of the present application, the SL PRS reception UE may receive resource pool configuration information of a set of resource pool from the network side, e.g., from a gNB, wherein each resource pool of the set of resource pool is configured to be corresponding to one or more positioning accuracy levels. The SL PRS reception UE will transmit the request information, e.g., the triggering signalling in the resource pool corresponding to one or more positioning accuracy level(s). The SL PRS reception UE also receives the SL PRS in a resource pool at least corresponding to the positioning accuracy level of the set of resource pool.

In addition, as stated above, for channel access on unlicensed band, at SL PRS transmission UE side, if LBT is used for subsequent SL PRS transmission, the SL PRS is transmitted after a channel access detection. At least one of a contention window size and back-off time of the channel access detection is associated with the positioning accuracy level. Accordingly, the SL PRS is received after the channel access detection by the SL PRS reception UE.

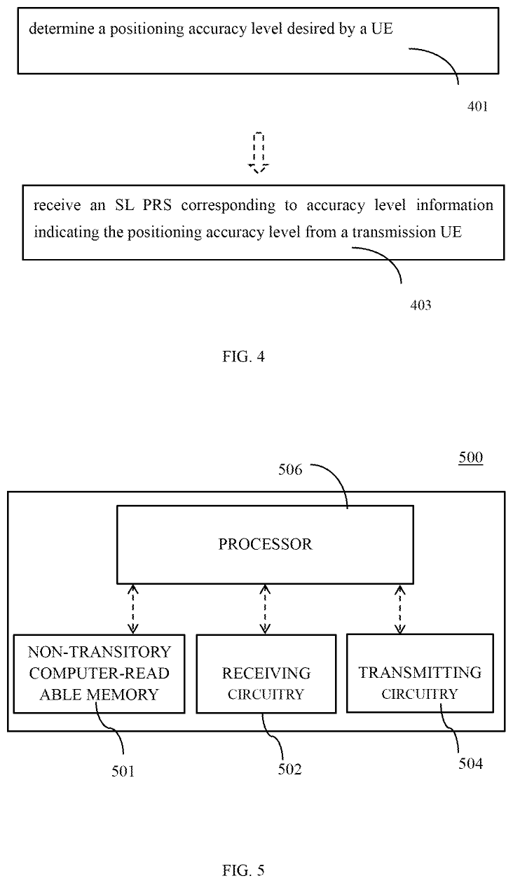

FIG. 5 illustrates a block diagram of an apparatus of SL positioning 500 according to some embodiments of the present application.

As shown in FIG. 5, the apparatus 500 may include at least one non-transitory computer-readable medium 501, at least one receiving circuitry 502, at least one transmitting circuitry 504, and at least one processor 506 coupled to the non-transitory computer-readable medium 501, the receiving circuitry 502 and the transmitting circuitry 504. The at least one processor 506 may be a CPU, a DSP, a microprocessor etc. The apparatus 500 may be a network apparatus, e.g., a gNB or a UE, e.g., an SL PRS transmission UE or SL PRS reception UE configured to perform a method illustrated in the above or the like.

Although in this figure, elements such as the at least one processor 506, transmitting circuitry 504, and receiving circuitry 502 are described in the singular, the plural is contemplated unless a limitation to the singular is explicitly stated. In some embodiments of the present application, the receiving circuitry 502 and the transmitting circuitry 504 can be combined into a single device, such as a transceiver. In certain embodiments of the present application, the apparatus 500 may further include an input device, a memory, and/or other components.

In some embodiments of the present application, the non-transitory computer-readable medium 501 may have stored thereon computer-executable instructions to cause a processor to implement the method with respect to the network apparatus as described above. For example, the computer-executable instructions, when executed, cause the processor 506 interacting with receiving circuitry 502 and transmitting circuitry 504, so as to perform the steps with respect to the network apparatus as depicted above.

In some embodiments of the present application, the non-transitory computer-readable medium 501 may have stored thereon computer-executable instructions to cause a processor to implement the method with respect to the SL PRS transmission UE or the SL PRS reception UE as described above. For example, the computer-executable instructions, when executed, cause the processor 506 interacting with receiving circuitry 502 and transmitting circuitry 504, so as to perform the steps with respect to the SL PRS transmission UE or the SL PRS reception UE as illustrated above.

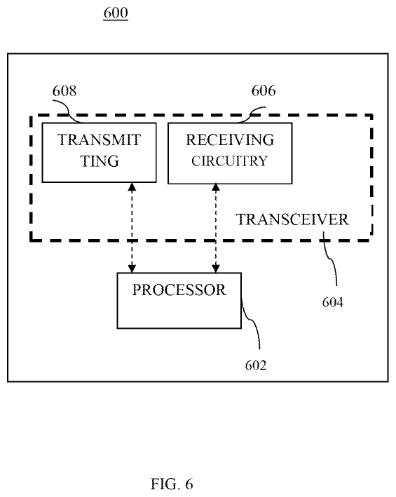

FIG. 6 is a block diagram of an apparatus of SL positioning according to some other embodiments of the present application.

Referring to FIG. 6, the apparatus 600, for example a master node or a slave node may include at least one processor 602 and at least one transceiver 604 coupled to the at least one processor 602. The transceiver 604 may include at least one separate receiving circuitry 606 and transmitting circuitry 608, or at least one integrated receiving circuitry 606 and transmitting circuitry 608. The at least one processor 602 may be a CPU, a DSP, a microprocessor etc.

According to some embodiments of the present application, when the apparatus 600 is an SL PRS transmission UE, the processor is configured to: transmit, via the at least one transmitting circuitry, accuracy level information indicating a positioning accuracy level associated with the UE to a set of reception UE; and transmit, via the at least one transmitting circuitry, an SL PRS corresponding to the positioning accuracy level information to a reception UE, wherein the reception UE is one of the set of reception UE or not.

According to some other embodiments of the present application, when the apparatus 600 is an SL PRS reception UE, the processor may be configured to: determine a positioning accuracy level desired by the UE; and receive, via the at least one receiving circuitry, an SL PRS corresponding to accuracy level information indicating the positioning accuracy level from the transmission UE.

According to some other embodiments of the present application, when the apparatus 600 is a network apparatus, the processor may be configured to: configure at least one of: a plurality of positioning accuracy levels for PRS transmission; and priorities of the plurality of positioning accuracy levels for the PRS transmission; and transmit, via the at least one transmitting circuitry, to a UE, configuration information indicating at least one of: the level configuration information and the priority configuration information.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus, including a processor and a memory. Computer programmable instructions for implementing a method are stored in the memory, and the processor is configured to perform the computer programmable instructions to implement the method. The method may be a method as stated above or other method according to an embodiment of the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method as stated above or other method according to an embodiment of the present application.

In addition, in this disclosure, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The terms “having,” and the like, as used herein, are defined as “including.”

1. A user equipment (UE), comprising:
at least one memory;
and
at least one processor coupled to the at least one memory,
and configured to cause the UE to:
transmit, to a set of reception UEs, accuracy level information indicating a positioning accuracy level associated with the UE.

2. The UE of claim 1, wherein, the accuracy level information is transmitted in sidelink control information.

3. (canceled)

4. The UE of claim 1, wherein, the positioning accuracy level is one of a plurality of positioning accuracy levels, and the plurality of positioning accuracy levels are predefined or configured based on at least one of the following:
a calculation manner of an absolute position of a sidelink positioning reference signal (PRS) transmission UE;
a calculation entity of an absolute position of a sidelink PRS transmission UE; or
a combination of the calculation manner with the calculation entity of an absolute position of a sidelink PRS transmission UE.

5. The UE of claim 1, wherein, the at least one processor is configured to cause the UE to:
receive resource pool configuration information of a set of resource pools from a network apparatus, wherein each resource pool of the set of resource pools is configured to correspond to one or more positioning accuracy levels.

6.-7. (canceled)

8. A user equipment (UE), comprising:
at least one memory;
and
at least one processor coupled to the at least one memory
and configured to cause the UE to:
receive accuracy level information indicating a positioning accuracy level from a transmission UE.

9. The UE of claim 8, wherein, the positioning accuracy level is one of a plurality of positioning accuracy levels, and the plurality of positioning accuracy levels are predefined or configured based on at least one of the following:
a calculation manner of an absolute position of a sidelink positioning reference signal (PRS) transmission UE;
a calculation entity of an absolute position of a sidelink PRS transmission UE; or
a combination of the calculation manner with the calculation entity of an absolute position of a sidelink PRS transmission UE.

10. The UE of claim 8, wherein, the at least one processor is configured to cause the UE to:
receive resource pool configuration information of a set of resource pools from a network apparatus, wherein each resource pool of the set of resource pools is corresponds to one or more positioning accuracy levels.

11. The UE of claim 10, wherein, the at least one processor is configured to cause the UE to:
receive a sidelink positioning reference signal (PRS) in a resource pool that corresponds to the positioning accuracy level of the set of resource pools.

12. The UE of claim 11, wherein, the sidelink PRS is received after a channel access detection, and at least one of a contention window size and back-off time of the channel access detection is associated with the positioning accuracy level.

13. A network apparatus, comprising:
at least one memory;
and
at least one processor coupled to the at least one memory and
configured to cause the network apparatus to:
configure at least one of:
level configuration information on a plurality of positioning accuracy levels for positioning reference signal (PRS) transmission; and
priority configuration information on priorities of the plurality of positioning accuracy levels for the PRS transmission; and
transmit to a UE, configuration information indicating at least one of: the level configuration information and the priority configuration information.

14. The network apparatus of claim 13, wherein the at least one processor is further configured to cause the network apparatus to: transmit resource pool configuration information of a set of resource pools, wherein each resource pool of the set of resource pools is configured to correspond to one or more of the plurality of positioning accuracy levels.

15. The network apparatus of claim 13, wherein, the plurality of positioning accuracy levels are predefined or configured based on at least one of the following:
a calculation manner of an absolute position of a sidelink PRS transmission UE;
a calculation entity of an absolute position of a sidelink PRS transmission UE; or
a combination of the calculation manner with the calculation entity of an absolute position of a sidelink PRS transmission UE.

16. The UE of claim 1, wherein the at least one processor is further configured to cause the UE to:
transmit, to the set of reception UEs, a sidelink positioning reference signal (PRS) corresponding to the accuracy level information associated with the position accuracy level for the UE.

17. The UE of claim 16, wherein the at least one processor is configured to transmit the sidelink PRS in response to request information received from the set of reception UEs.

18. The UE of claim 16, wherein the at least one processor is further configured to cause the UE to:
receive resource pool configuration information of a set of resource pools from a network apparatus,
wherein each resource pool of the set of resource pools is configured to correspond to one or more positioning accuracy levels; and
transmit the sidelink PRS in a resource pool at least corresponding to the positioning accuracy level of the set of resource pools.

19. The UE of claim 16, wherein the at least one processor is configured to cause the UE to transmit the sidelink PRS after a channel access detection, wherein at least one of a contention window size or a back-off time of the channel access detection is associated with the positioning accuracy level.

20. A processor for wireless communication, comprising:
at least one controller coupled with at least one memory and configured to cause the processor to:
transmit, to a set of reception UEs, accuracy level information indicating a positioning accuracy level associated with the processor.

21. The processor of claim 20, wherein the at least one controller is further configured to cause the processor to transmit, to the set of reception UEs, a sidelink positioning reference signal (PRS) corresponding to the accuracy level information associated with the position accuracy level for the processor.

22. The processor of claim 20, wherein the accuracy level information is transmitted in sidelink control information.

23. The processor of claim 20, wherein the at least one controller is configured to:
receive resource pool configuration information of a set of resource pools from a network apparatus, wherein each resource pool of the set of resource pools is configured to correspond to one or more positioning accuracy levels.
